(19) United States
(12) Patent Application Publication
(10) Pub. No.: US 2012/0198754 A1
(43) Pub. Date: Aug. 9, 2012

(54) System and Method for a Barrier Installation to Control Bed Bugs

(76) Inventor: Michael Tarnower, Pine Lake, GA (US)

(21) Appl. No.: 13/366,104

(22) Filed: Feb. 3, 2012

Related U.S. Application Data
(60) Provisional application No. 61/440,064, filed on Feb. 7, 2011.
(60) Provisional application No. 61/582,061, filed on Dec. 30, 2011.

(51) Int. Cl. A01M 1/00; A01M 1/10

(52) U.S. Cl. 43/123; 43/132.1

(57) ABSTRACT

The present invention provides for a bed bug control system comprised of a map apparatus and bed bug control barrier apparatus. The map apparatus provides a method to design, engineer and install bed bug control barrier apparatus targeting locations where bed bugs either travel or locate. Installation of the bed bug control barrier apparatus will intersect multiple paths a bed bug moving naturally with free locomotion could take in an uninterrupted pathway to or from a feeding opportunity. Bed bugs contacting the bed bug control barrier apparatus will either be caught or killed. The system and method of this invention provides for bed bug eradication, detection and monitoring of bed bugs and other pests, a durable and sustainable installation, replaceable cartridges allowing for a multitude of ingredients, seamless and scalable incorporation into either new or existing interior environments, and custom designs and visual appearances for a multitude of interior environments.

### CROSS-REFERENCE TO RELATED APPLICATIONS

Provisional application No. 61/440,064 filed on Feb. 7, 2011.

Provisional application No. 61/582,061 filed on Dec. 30, 2011.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not Applicable

### BACKGROUND

1. Field of the Invention

The present invention is in the technical field of pest control, specifically in the art of controlling the pest cimex lectularius, hereafter referred to as a bed bug or bed bugs.

2. Description of Prior Art

Conventional pest management solutions intending to control bed bugs such as residual pesticides; stationary barrier devices that connect or associate to furniture walls, baseboards or other objects in an interior environment without both full continuity encompassment and a durable seal; mattress encasements; local applications of heat and freezing; chemical lures with traps; and the like are typically either substantially ineffective or are only effective for short periods of time—typically less than six months.

It is difficult to effectively employ conventional chemical products for an extended period of time because bed bugs rapidly develop resistance to residual pesticides. Further, prior residual pesticide applications and interior devices cannot operate effectively for the extended time period of months and years during which bed bugs remain viable in an interior environment. Further, current stationary devices are ineffective because bed bugs routinely avoid stationary traps and non-continuous barriers as they move about. Further, current stationary barrier devices are ineffective because bed bugs will routinely travel in areas wherever the barriers are missing. Further, bed bugs aggregate in small colonies that may locate into areas away from the feeding locations. Further, current stationary barrier devices are ineffective because they fail to stay securely sealed and are not durably resistant to dislocation by either force or the effects of material degradation over time. Further, prior residual pesticide applications, chemical lures and stationary trap devices fail to control the vector distribution of bed bugs as the bed bugs routinely and randomly relocate from any one location into any and all geographically associated locations by either free locomotion or hitchhiking. Further, prior residual pesticide applications, chemical lures and stationary trap devices fail to control the vector distribution of bed bugs due to the serial egg laying activities of the female bed bug whereby nymph bed bugs will sequentially hatch along all areas where the inseminated female bed bug travels for so long as the eggs in her abdomen remain viable. Further, due to their temporary efficacy and failure to adequately provide comprehensive installation applications, prior residual pesticide applications, traps, barriers, lures, encasements and interior devices cannot operate effectively for the extended time period of months and years when bed bugs remain viable either in or en route to interior environments where the presence of bed bugs is or will be a problem.

Routinely, inventors have focused on limited goals when inventing tools, chemicals and methods to kill and trap bed bugs. For example, in US20100043274 to Battick (2010), US20100043275 to Battick (2010), U.S. Pat. No. 7,676,985 Blto Perkins (2010), U.S. Pat. No. 8,020,341 B2 to Ramos et al (2011), US20110239366 to Boyle et al (2011), US20110225873 to McKnight et al (2011), US 20110203158 to Gilles (2011), US20100212213 to Hope at al (2010), and other included prior art:

inventors fail to teach how to treat vast and diverse areas where bed bugs may be both active and viable;

prior art fails to teach the benefits of a structurally sound assembly and a sustainably durable installation necessary to successfully treat and eradicate bed bugs for a period of years and decades;

prior art provides minimal and ineffective guidance for users to manage the visual appearance and related aesthetic considerations of a passive barrier system; and

prior art fails to teach how years of chemical exposure will remain effective against the bed bug while, at the same time, operate without damaging people and animals in the same interior environment.

In the battle against bed bugs, in order to control where and when they are killed, it is necessary to employ strategic opportunities targeting their strengths and weaknesses.

Among the documented strengths of bed bugs:

they are able to locate safe havens and outwait almost any problem or threat related to feeding or predation;

they develop physical resistance to chemical threats very quickly;

they are mobile and adventurous even when well-located to a feeding source;

they form groupings of small colonies and do not have centralized nests;

they will aggregate and colonize in clusters away from a feeding area;

they can effectively populate in an environment with as few as one or two bugs;

the females distribute eggs everywhere they go;

they relocate effectively by hitchhiking with people and their effects; and

they are well-adapted to living for long periods of time without feeding.

Among the documented weaknesses of bed bugs:

they are physically weak, structurally fragile and easy to kill;

they are relatively slow and easy to catch;

they are subject to predation and are basically defenseless;

they can't leap, jump or fly;

they are generally easy to detect and are only moderately stealthy while feeding;

they do not enjoy strength in numbers within a local population;

they have only a single preferred food source; and

they are exposed to many risks when not located in or near a safe haven.

### BRIEF SUMMARY OF THE INVENTION

The present invention relates a method to evaluate and interpret an architectural interior by way of a bed bug control system comprised of a map apparatus and a bed bug control barrier apparatus to determine and intersect pathways available for the free locomotion attributes and location behaviors of the pest cimex lectularius, hereafter referred to as a bed bug or bed bugs. Further, the present invention employs and describes specific embodiments to control bed bugs. Further, the present invention relates a method to establish locations for the various apparatus described in this application. Further, the present invention relates a method to select barrier device configurations appropriate to a given location. Further, the present invention relates a method to install a given apparatus in order to control, trap, monitor, abate and eradicate bed bugs. Further, the present invention relates a method to differentiate one interior area from another interior area. Further, the present invention relates a method to categorically prioritize the interior areas so described. Further, the present invention relates a method to employ and implement a bed bug control barrier system into any and all architectural interiors.

### BRIEF DESCRIPTION OF THE DRAWINGS

Various embodiments of the present invention are described and illustrated herein, in which:

FIG. 1 is a flowchart, referencing FIG. 2 through FIG. 8, illustrating the basic method for producing a map apparatus.

FIG. 2 shows a common, partial plan view of a typical residential interior to illustrate a treatment zone;

FIG. 3 shows FIG. 2 with added images depicting isolation zones, protection zones and quarantine zones.

FIG. 4 shows the contiguous surface areas from the plan view of FIG. 2 and adds descriptions to the various surfaces.

FIG. 5 shows the image from FIG. 3 and depicts identifiable bed bug pathways.

FIG. 6 shows the image from FIG. 4 and adds images depicting locations for bed bug control apparatus and adds an image of one legend specifying assignments for said barriers. Additional legends for any and all specifications for parts lists and installation information may be included.

FIG. 7 shows the image from FIG. 4 and adds images depicting locations for additional bed bug control apparatus and adds an image of one legend specifying assignments for said barriers. Additional legends for any and all specifications for parts lists and installation information may be included.

FIG. 8 shows the image of a partial area derived from FIG. 2. The image shows the floor zone and one contiguous wall surface. FIG. 8 adds images depicting protection zones, quarantine zones, and a legend for bed bug control barrier apparatus locations and specifications. Said barriers located in protection zones and in quarantine zones are typically secured by the weight of objects such as the bedding, mattress and foundation. Additional legends for any and all specifications for parts lists and installation information may be included.

FIG. 9 shows a sectional view of a typical bed bug control apparatus barrier apparatus illustrating an assembly containing the (1) surface seal elements, (2) container elements, (3) cartridge elements and (4) cover elements as typically installed to a wall surface at a baseboard location. Said barriers mounted to interior surfaces are typically secured by at least mechanical attachments.

FIG. 10 shows a sectional view of a typical bed bug control apparatus barrier apparatus illustrating an assembly containing the (1) surface seal elements, (2) container elements, (3) cartridge elements and (4) cover elements as typically installed to a floor surface at a door threshold location. Said barriers mounted to interior surfaces are typically secured by at least mechanical attachments.

FIG. 11 shows a perspective view of a typical section of a bed bug control barrier apparatus mated to connector apparatus for altering the path and direction of said barrier apparatus in a different plane. The illustrated bed bug control barrier apparatus and connector apparatus are comprised of (1) surface seal elements, (2) container elements, (3) cartridge elements and (4) cover elements. Said barriers mounted to interior surfaces are typically secured by at least mechanical attachments.

FIG. 12 shows a perspective view of a typical section of a bed bug control barrier apparatus mated to connector apparatus for altering the path and direction of said barrier apparatus in the same plane. The illustrated bed bug control barrier apparatus and connector apparatus are comprised of (1) surface seal elements, (2) container elements, (3) cartridge elements and (4) cover elements. Said barriers mounted to interior surfaces are typically secured by at least mechanical attachments.

### ADDITIONAL NOTES ON THE DRAWINGS

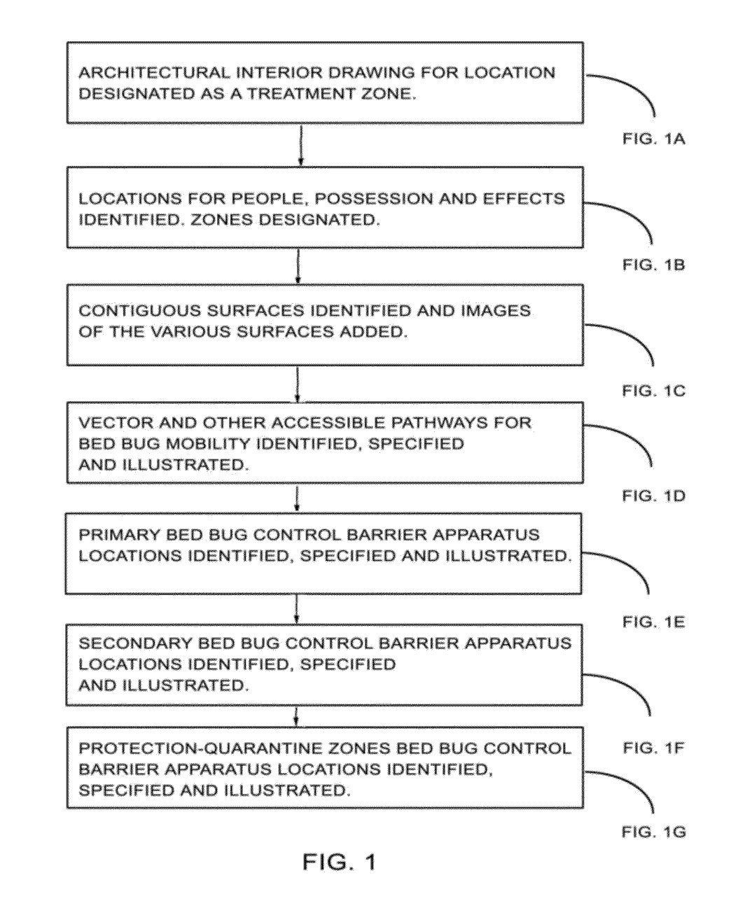

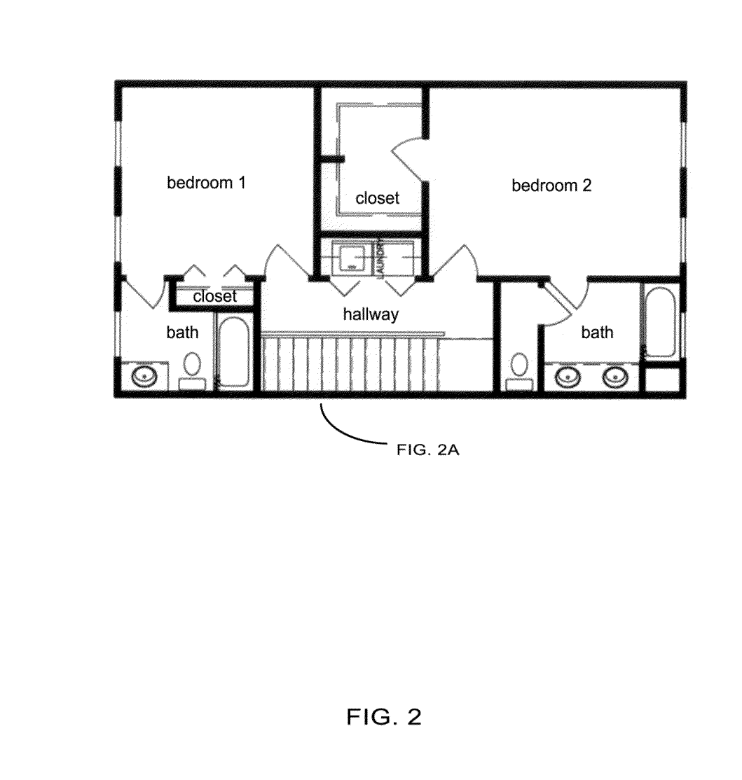

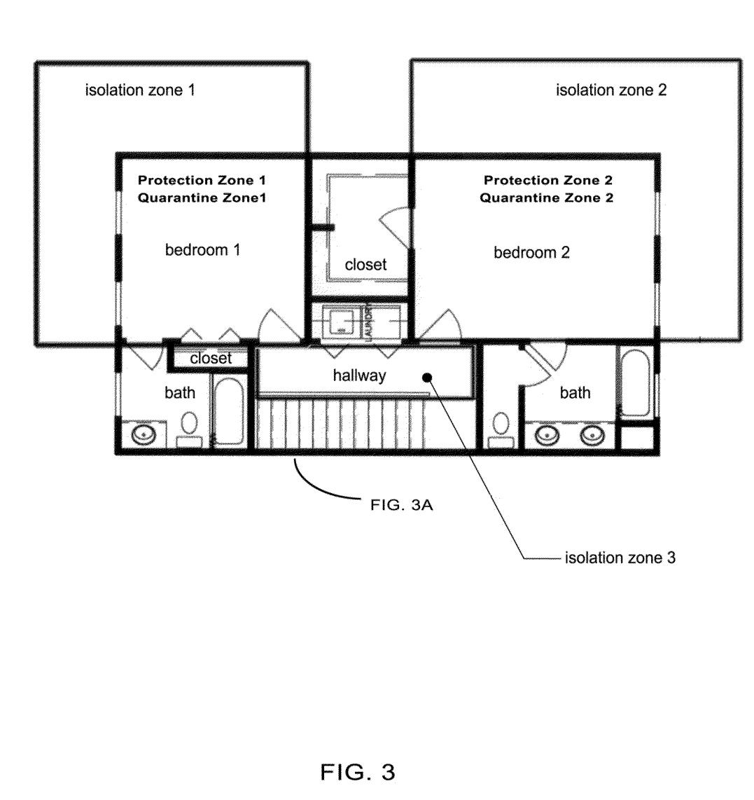

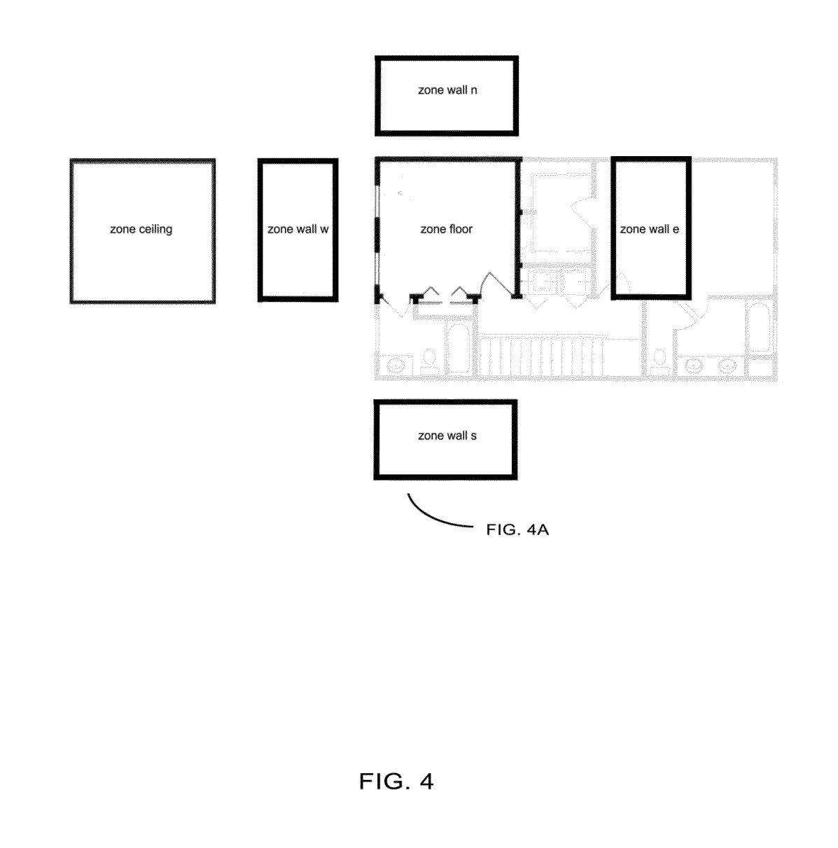

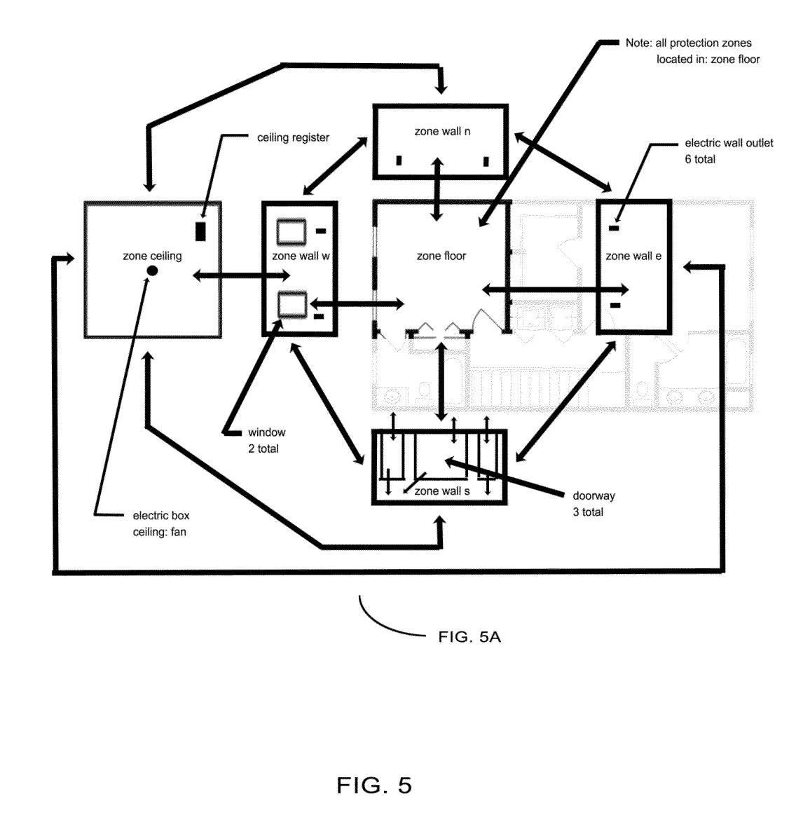

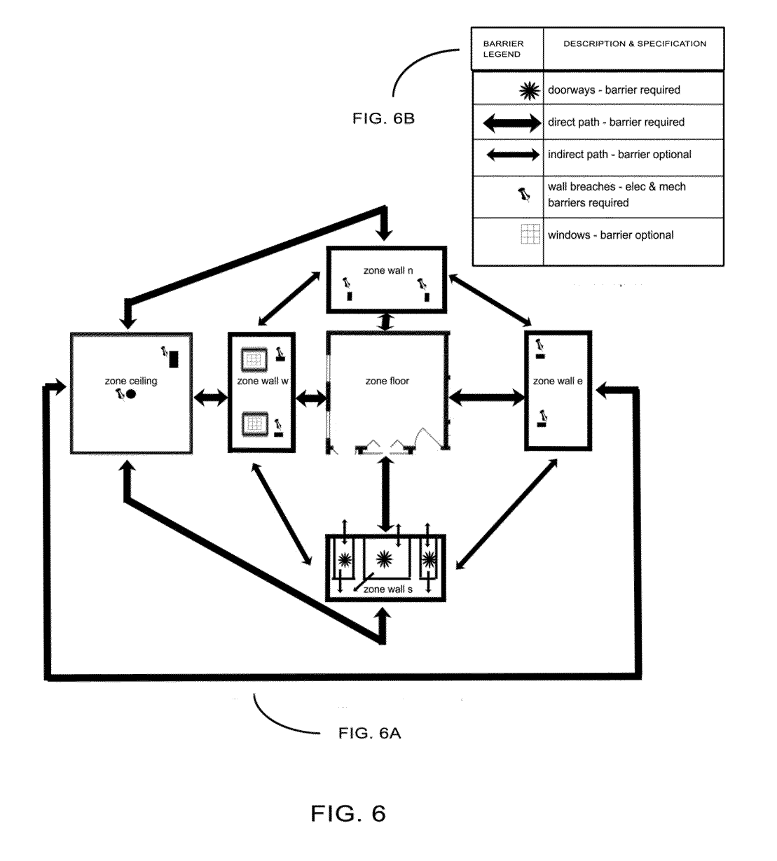

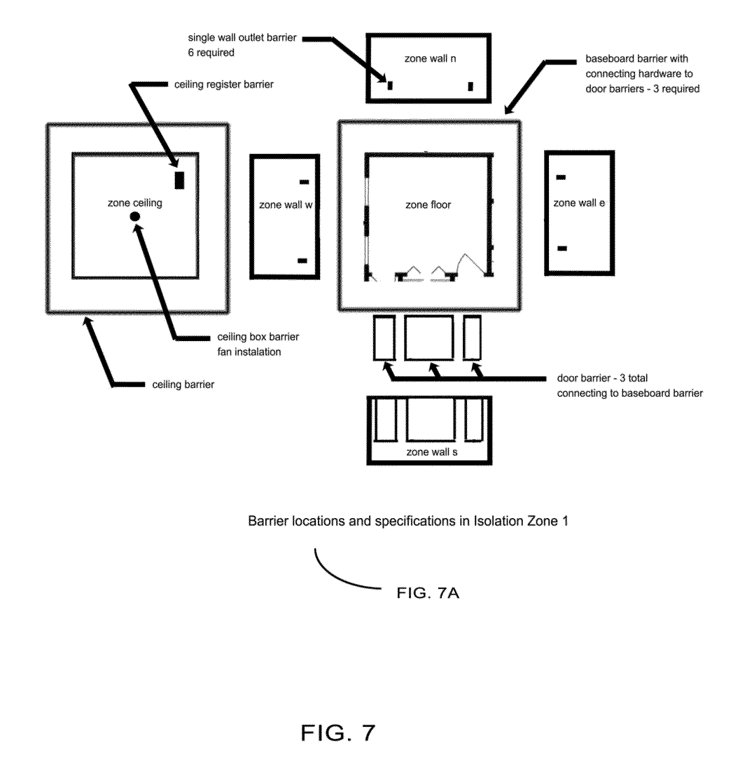

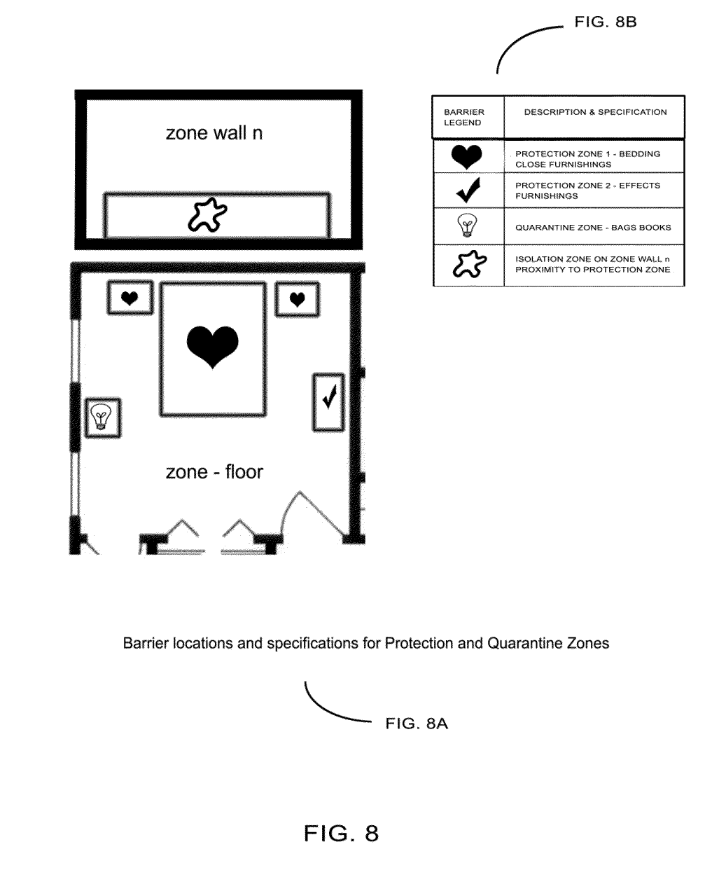

FIG. 1 is a flowchart of a method for producing a map apparatus embodiment of the present invention. FIG. 1A corresponds to FIG. 2. FIG. 2 represents a treatment zone in a typical architectural floor plan where bed bugs either are or are considered to be a problem. The area consists of two bedrooms, a hallway, bathroom and closets. FIG. 1B corresponds to FIG. 3. FIG. 3 takes the same floor plan and, FIG. 3A, identifies and assigns isolation zones, protection zones and quarantine zones. FIG. 1C corresponds to FIG. 4. FIG. 4 takes the same floor plan, FIG. 4A, adds images of the contiguous surfaces in bedroom land assigns identifying labels to each of the various surfaces. FIG. 1D corresponds to FIG. 5. FIG. 5 takes the image from FIG. 4, establishes the vector paths and access locations available to a bed bug, and, FIG. 5A, adds images depicting the pathways. FIG. 1E corresponds to FIG. 6. FIG. 6 represents the analysis of the pathway information illustrated in FIG. 5. FIG. 6A depicts the priority basis for assigning bed bug control barrier apparatus and FIG. 6B is a legend illustrating said barrier assignments. FIG. 1F corresponds to FIG. 7. FIG. 7 depicts the same floor plan in FIG. 6. FIG. 7A depicts specific bed bug control barrier apparatus installation locations, defines the type specification to each of the said barriers and depicts the quantity of each of the said barriers. FIG. 1G, corresponds to FIG. 8. FIG. 8 represents the protection and quarantine zones of bedroom 1 as located in FIG. 3. FIG. 8A illustrates the location assignments for the bed bug control barrier apparatus and the legend, FIG. 8B, illustrates specifications related to the various assignments of said barriers. An isolation zone and a bed bug control barrier apparatus assignment utilizing connector elements as illustrated in FIG. 12 is depicted on, FIG. 8A, zone-wall-n.

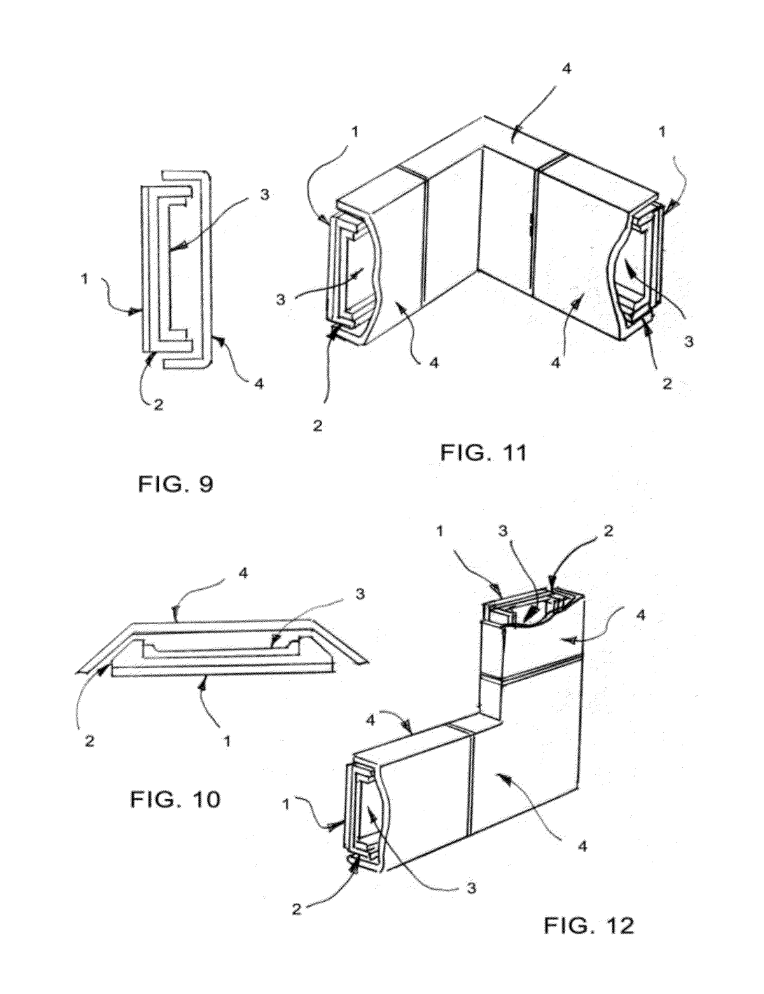

FIG. 9 through FIG. 12 illustrate assemblies typical to the bed bug control barrier apparatus. Said apparatus is typically comprised of (1) a surface seal element, (2) a container element, (3) a cartridge element and (4) a cover element. The component elements may be combined or altered as necessary to conform to specific conditions present at the installation location.

Bed bug control barrier apparatus are typically specified per the map apparatus to install at or near intersections and junctures of contiguous surfaces. Said barriers may be specified to be incorporated by manufacturing into architectural moldings and details. Said barriers may be installed at locations away from contiguous surface junctures such as but not limited to wall surfaces such that said barriers frame around interior furnishings such as but not limited to bed furniture, dressers, nightstands, entertainment centers, wardrobes, vanities and bookcases. If either the closet, the bath or the hallway or ant such space were designated on the map apparatus to possess included isolation, quarantine or protection zones, a user would generate a bed bug control barrier apparatus installation with specifications consistent with the method and system described by this invention. If a user determines either the closet, bath or hallway need to be connected to the treatment zone or classified as an independent treatment zone, said user would revise the map apparatus and specifications as described in the method and system of this invention.

Consistent with the stated guidance to improve overall system performance, if a user initially determines the closet, the bath and the hallway do not possess included isolation or protection zones and will not be designated as connected to the treatment zone, a user of this method and system may at a later date selectively enlarge the treatment zone of the map apparatus and may specify to install said barriers for either prophylactic or another purpose into the closet, hallway and other additional, physically associated spaces as may be established by an expanded floor plan of the architectural interior and thus incorporated into a map apparatus.

The flexible nature of this method and system for the purpose of controlling bed bugs allows for adaptive design and may therefore be applied to any and all architectural interiors and physical designs. Further, the flexible nature of this method and system for the purpose of controlling bed bugs allows for the manufacturing integration of this invention into any and all architectural details, trim and molding for the benefit of appearance designs, mechanical hardware attachment and mechanical assemblies. Further, the flexible nature of this method and system for the purpose of controlling bed bugs allows for the manufacturing integration of this invention into any and all interior furnishings consistent with the map apparatus and bed bug control barrier apparatus provisions in this application.

The map apparatus, bed bug barrier control apparatus, location and design procedures, installation standards and cartridges illustrated in the drawings are identified as being consistent with the inherent flexibility of the method and system of this invention. Further, the method and system of this invention allows for any and all configurations based on appearance, sizing, structural strength, manufacturing practices, fabrication materials, and maintenance requirements.

### DETAILED DESCRIPTION OF THE INVENTION

The present invention is a method and system to design, engineer and install a structural bed bug control system consisting of more than one bed bug control barrier apparatus is identified and specified for installation by means of a map apparatus such that the said barriers are either contiguous or non-contiguous and arranged so that the each said barrier intersects at least one path a bed bug moving naturally with free locomotion could take in an uninterrupted pathway to or from a feeding opportunity.

Installation locations for the bed bug control barrier apparatus are based on a method for producing a map apparatus which first identifies by this invention an area described as a treatment zone where bed bugs are to be controlled. All treatment zones and other designated zones described by this invention as isolation zones, protection zones, surface break zones and quarantine zones are determinable by any and all optional terminology to relate to the same determination of purpose. Further, a treatment zone may be equivalent to any subordinate zone, whereby the treatment zone is limited to a single object or area such as but limited to a solitary bed, sofa or room. Further, a treatment zone may be determined to encompass the entirety of a building or campus of buildings of any and all dimensions and intended uses. Further, a treatment zone may be determined to comprise lesser included environments such as but not limited to office cubicles, shipping containers, theater seating, furniture and any and all effects in an architectural interior with either fixed or flexible dimensions.

All contiguous surfaces and areas designated as a treatment zone within a selected architectural interior are identified onto an architectural floor plan of the project area or a functional equivalent of such. Within the treatment zone are added descriptions of all structural surfaces and furnishings and their orientation. All surfaces and furnishings identified as locations where bed bugs have direct parasitic access to people are designated as protection zones. All surface and furnishing areas identified as locations where bed bugs can be either resident or moving about with functional proximity to a protection zone are designated as isolation zones.

Functional proximity may include areas such as but not limited to hallways, commercial warehouses, libraries, office cubicles, any and all office areas where people congregate, any and all office areas where books and loose paper may be present such as but not limited to break rooms and eating areas, general office storage rooms, any and all theaters, any and all stocking rooms, any and all restaurant areas where people may congregate, any and all commercial business areas where people may congregate, any and all public and private transportation areas where people may congregate, and any and all other areas bearing similarity to these described areas.

In the event that an interior does not have a protection zone area but has at least one area determinable to be an isolation zone, a treatment zone may be designated to encompass the isolation zone or zones. In the event that an interior does not have a protection zone or isolation zone area, a treatment zone may be designated to any and all prophylactic barrier installations comprised of any and all system design methods and parts described by this invention.

Any and all holes in any and all architectural surfaces in the treatment zone are described by this invention as surface break zones. Any and all surface break zones located on surfaces and furnishings that can advance the position of a bed bug towards a protection zone or isolation zone in the treatment zone are designated as uninterrupted pathways accessible to the free locomotion attributes of a bed bug and are identified as such on the map apparatus.

Any and all methods for utilizing a quarantine zone for any and all objects determined to be mobile such as but not limited to books, bags, clothes, tools, shipping containers of any and all dimensions, parcels, general mail, and any and all other items which are routinely transported from one location to another may be designated as treatment zone areas and may reside in an interior that may or may not have a protection zone or an isolation zone as described by this invention.

Bed bug control barrier apparatus are substantially sited at the intersection of contiguous surfaces identified as pathways accessible to a bed bug. Bed bug control barrier apparatus are added to the system design until all such paths leading to any and all areas designated as protection and isolation zones have more than one bed bug control barrier apparatus intersecting determinable bed bug pathways. Further, isolation zones have a minimum of one bed bug control barrier apparatus directly fixed to the designated objects and/or furnishings. Further, protection zones have more than one bed bug control barrier apparatus directly fixed to the designated objects and/or furnishings.

Users of this invention will map and engineer an installation design tailored to the use and need requirements of any and all interior environments where bed bugs are to be controlled. Users of this invention will install surface seals, container assemblies, covers and cartridges along with all necessary connector apparatus. Users will install this continuity designed bed bug control system with any all necessary connector apparatus in order to obstruct, trap, capture, control and monitor the local movement, vector distribution and access to feeding opportunities of bed bugs. Users will install covers and all necessary connector apparatus to complete an installation.

The bed bug control barrier apparatus are securely attached with fastening hardware to architectural interior surfaces, underlying structures, interior furnishings and any and all fixed positions suited to the installation. In addition, the system provides for bed bug control barrier apparatus attached to any and all interior furnishings and objects to be primarily secured by gravitational force combined with the weight of objects such that said barrier is securely immobile and firmly sealed with minimal or no mechanical attachment.

The installed layers of bed bug control barrier apparatus are either securely fastened by mechanical means or pressed into place by gravitational force combined with the weight of objects such that said barrier is securely located. The layers of bed bug control barrier apparatus are securely sealed by a combination of mechanical assemblies and gravitational force to continuous and non-continuous planar surfaces. The layers of bed bug control barrier apparatus may be, when necessary, suspended between surfaces in order to maintain perimeter continuity. Suspended bed bug control barrier apparatus require additional mechanical strength engineered to the specifications within a given architectural interior.

The structural bed bug control system substantially consists of seals, container assemblies, connector apparatus, cartridges, attachment hardware and covers. The bed bug control barrier apparatus are systematically layered in order to encapsulate and protect a target zone or zones from any and all nearby surface areas suitable to the free locomotion attributes of a bed bug. Further, in the event that a bed bug breaches any perimeter ring of the barrier system either by hitchhiking or free locomotion into or near to a protection or isolation zone, the bed bug will, upon exercising free locomotion to leave the area, intersect a bed bug control barrier apparatus. Further, in the event that a bed bug breaches any bed bug control barrier apparatus of the bed bug control system by hitchhiking into or near to a protection or isolation zone and then remains inside that protection or isolation zone, the bed bug will be unable to secure safe harbor or hitchhike out from that area.

Surface mount seals and apparatus seals are present on all installation surfaces and at all locations where cracks and crevices that breach a bed bug control barrier apparatus are either present or likely to occur. Surface mount seals and apparatus seals are scalable, attach by a plurality of secure mechanical means and vary in both size and visual appearance.

Container assemblies and associated connector apparatus may be present in the entirety of a bed bug control barrier apparatus. Container assemblies and associated connector apparatus are scalable, attach by a plurality of secure mechanical and gravitational means and vary in both size and visual appearance. Container assemblies and associated connector apparatus can be constructed from any common structural material in order to meet the installation and appearance criteria for a given architectural interior.

Cartridges and associated connector apparatus may be present in the entirety of a bed bug control barrier apparatus. Cartridges and associated connector apparatus are scalable, attach by a plurality of secure mechanical means and vary in both size and visual appearance. Cartridges and associated connector apparatus have no fixed physical configuration other than they substantially fulfill the requirements to establish a continuous perimeter, fit securely onto the container assemblies and reside in the enclosure of the bed bug control barrier apparatus.

Covers and associated connector apparatus may present in the entirety of a bed bug control barrier apparatus. Covers and associated connector apparatus are scalable, attach by a plurality of secure mechanical means and vary in visual appearance. All covers and associated connector apparatus are removable in an intact form suitable for reinstallation or replacement. Covers and associated connector apparatus provide for visual inspection, monitoring, maintenance, and cartridge replacement. Covers and associated connector apparatus are replaceable in the event of physical damage or to change the visual appearance of the installation.

Cartridges and associated connector apparatus as presented in this application are shown to be typical and serve as examples for a typical installation. Cartridges and associated connector apparatus as presented in this application fulfill the requirements for continuity and attachment. Cartridges and associated connector apparatus as presented in this application do not contain an ingredient list. Cartridges and associated connector apparatus are categorized in one of two ways—as either a device or a product. Any cartridge segment containing only sticky surface capture, gel or other viscous material, fibers and exempt inert trapping ingredients is considered a device by the Environmental Protection Agency (EPA) and does not require registration when installed onto the perimeter barrier mounting platform. A cartridge segment is considered a product requiring registration with the Environmental Protection Agency (EPA) if it contains any ingredient substances or chemicals intended to lure, repel, desiccate or poison bed bugs. Any and all cartridge segments meeting the EPA definition of a product are not eligible to be installed onto the perimeter barrier mounting platform unless registered with the Environmental Protection Agency (EPA).

The various forms of installation apparatus, container assemblies and cartridges are specifically designed, engineered and constructed so as to act upon the bed bugs in environments such as, but not limited to, homes, apartments, condominiums, group residences, hotels, motels, hospitals, dormitories, residence halls, office spaces, modular cubicles, libraries, commercial businesses, commercial warehouses, theaters, store and library fixtures, public transportation equipment, jails, prisons and any and all interior spaces and furnishings where bed bugs are or may become present. In addition, the construction and appearance of the installed layered perimeters are configurable to interior designs, thresholds, flooring, architectural moldings, suspended ceilings, any and all structural requirements, any and all building code requirements, any and all advertising, any and all promotional branding, and any and all forms of architectural details.

The collective installation of seals, container assemblies, cartridges, connector apparatus and covers are primarily purposed for the capture, monitoring, decimation and eradication of bed bugs. In addition, cartridge designs will be configurable to allow any and all devices and products intended to control other pests that enter into the effective range of the invention. Pesticide applications and baits targeting other pests can be ingredients in a cartridge product and are thus included in any and all specifications assigned to cartridge configurations identified in this invention.

The collective installation of seals, container assemblies, cartridges, connector apparatus and covers may include electronic equipment for the purposes of, but not limited to, system monitoring, visual inspections, testing processes and programs, installation and maintenance requirements, system alarms for any and all needs related to bed bug control, off-site management, and data integration with any and all residual pest control services located in functionally related architectural environments.

This application includes any and all embodiments of map apparatus and bed bug control barrier apparatus identified as appropriate within any and all interiors requiring any and all structured barrier apparatus as described herein as being in a system and method to control, trap, abate and eradicate bed bugs. Further, this system may include apparatus not illustrated in the included drawings that perform the prior described functions of barrier continuity, barrier location, installation methodology, architectural product integration, cartridge replacement, cartridge visual inspection, cartridge ingredients and the integration of electronic equipment for any and all purposes including but not limited to monitoring, maintenance, pesticidal purpose and incorporation into any and all other methods and systems of electronic equipment.

The boundary for the outermost bed bug control barrier apparatus installation requires a minimum of one non-contiguous bed bug control barrier apparatus surrounding an isolation or protection zone. As a matter of general guidance, adding outermost bed bug control barrier apparatus to intersect the free locomotion pathways of the bed bugs will improve overall system performance.

The user of this invention will create drawings and specifications to map the treatment zone in the interior environment to include any and all locations where the bed bug control system may be intended. Further, the user will create specifications and assignments to locate any and all bed bug control barrier apparatus intended based on any and all methods of guidance described by this invention.

The map apparatus may include an architectural floor plan. The map apparatus may include a floor plan adapted from any and all forms of architectural floor plans intended to illustrate the interior such that any and all barrier system design elements are designated. The map apparatus may include any and all illustrations from any and all forms of architectural interiors and any and all structural effects in an architectural interior intended to illustrate locations such that any and all barrier system design elements are to be designated. The map apparatus may include a legend including but not limited to designations as are described by this invention as protection zones; isolation zones; connector zones, designations for any and all other locations determined to be included in the treatment area; contiguous and non-contiguous junctures of adjacent surfaces; locations and descriptions of surface breaks including but not limited to electrical boxes, vents and grates, ducting and any and all other mechanical objects; designations for barrier locations; specifications for bed bug pathways and barrier installations; and any and all other elements within the map apparatus area a user determines for treatment. The map apparatus may include any and all other elements of information a user determines as necessary including but limited to schedules for labor, expenses, timetables, change orders, general notes and any and all other information elements associated to the barrier system. The map apparatus may be comprised of non-technical drawings consisting of handwritten notes and hand-drawn images.

The method of map apparatus may in full or in part be incorporated as a bed bug control system installation into any and all architectural plans used by but not limited to architects, architectural designers, commercial and residential construction businesses, businesses producing manufactured homes and any and all similarly constructed interiors, construction tradesmen, commercial and residential remodelers, home or do-it-yourself remodelers, union building trades, and any and all businesses producing architectural detail products manufactured for compatible use in this system and method including but not limited to moldings, suspended ceiling products, office cubicles, store and library fixtures, theater and similar seating, permanent and temporary stages, cabinetry, warehouse fixtures and constructed objects, and interior furnishings.

Employing the principles and guidelines established by this invention in this application will allow a user to expand the single location example as illustrated in the drawings such that a user may produce a map apparatus and specify the installation of bed bug control barrier apparatus and other apparatus to encompass the entirety of any and all architectural interiors and any and all included furnishings, effects and objects. Further, a user employing the principles and guidelines established by this invention in this application will be in substantial compliance with United States of America national, state and local building codes; and in substantial compliance with federal and state regulatory agencies such as but not limited to the Environmental Protection Agency (EPA), state agencies that manage pesticides, state and local building code authorities, and the Occupation Safety and Health Administration (OSHA).

### CONCLUSION, RAMIFICATIONS, AND SCOPE

Accordingly, the reader will see that the map apparatus procedure and specifications of this invention can be used to identify and locate apparatus and the preferred embodiments of this system easily and conveniently, can be applied to any and all locations where bed bugs are to be controlled, and can be fully integrated into both new and existing architectural interior environments. In addition, when cartridges are inspected, a user of this system will have visible evidence of, or the lack of, bed bug activity and measurable data going forward. Furthermore, the method and system of this invention has additional advantages in that:

it permits the user to customize a comprehensive solution for any and all architectural interior environments;

it permits full aesthetic versatility at any time by either simply replacing the cartridge covers or by relocating the cartridge assembly to a different map apparatus location for any and all interior design applications;

it allows the user to securely, over the course of years, maintain and select the appropriate cartridge apparatus for use in a specific bed bug control system;

it provides a method and means to monitor and evaluate bed bug control system performance and make improvements to the bed bug control barrier apparatus;

it provides principles and guidelines allowing a user to use the map apparatus to coordinate the bed bug control system from a single interior location and further specify an increasingly expansive bed bug control system to encompass the entirety of any and all nearby architectural interiors; and

it operates passively for the extended time period of months and years when bed bugs remain viable either in or en route to interior environments where their presence is or will be a problem.

Although the descriptions above and in the other sections of this application contain many specificities, these should not be construed as limiting the scope of the invention but as merely providing illustrations of some of the presently preferred embodiments of this invention. For example, the perimeter barriers may have shapes to match any and all architectural details; sizing of the preferred embodiments is fully scalable; the map apparatus and specification procedures may employ apparatus from any source meeting the operational criteria of this invention; etc.

Thus the scope of the invention should be determined by the appended claims and their legal equivalents, rather than by the examples given.

I claim:

1. A method for producing a map apparatus comprising images of at least one architectural interior containing drawings and other documents of said architectural interior selected from the group consisting of new and existing drawings and documents as a means to execute a plan for locating and installing a plurality of bed bug barrier apparatus in said architectural interior, comprising the steps of:
(a) the map apparatus of claim 1 wherein the said images further includes images of all surface areas substantially contiguous within said architectural interior space;
(b) the map apparatus of claim 1 wherein the said images further includes images representing locations where people, personal possessions, architectural objects, and personal effects may be substantially disposed in any approximate area for any determinable time;
(c) examining said images representing the contiguous surfaces, the locations where people, personal possessions, architectural fixtures, mechanical objects, and personal effects are located for the means to assess and identify vector and access points to thereby provide the means to locate bed bug pathways;
(d) examining said images representing the contiguous surfaces, the bed bug pathways, and the locations where people, architectural fixtures, mechanical objects, personal possessions, and personal effects are located for the means to assess and identify zone classifications and thereby provide the means to locate barrier apparatus;
(e) the map apparatus of claim 1 wherein the said images thither includes images depicting and locating pathways available to a bed bug;
(f) the map apparatus of claim 1 wherein the said images further includes images depicting and locating said barrier apparatus;
(g) processing the map apparatus with further included images representing said barrier apparatus to produce specifications for at least one or more parts lists, a multitude of map legends, a multitude of mechanical apparatus assemblies, a multitude of installation details, and a multitude of conventional application schedules common with work performed in architectural interior environments; and
(h) completing the map apparatus of claim 1 further includes employing at least three of the said steps.

2. A method for producing a structurally and dimensionally scalable bed bug control barrier apparatus comprising a surface seal element to block the path of a bed bug, a cartridge element containing at least one component to trap or kill a bed bug, a cover element substantially surrounding the cartridge element, a containing element sandwiched between the seal element and cover element and substantially surrounding the cartridge element, and with means for assembly to provide openings between the cover element and containing element.

3. The bed bug control barrier apparatus of claim 2 providing the means to fit structurally for installation to a multitude of locations.

4. The bed bug control barrier apparatus of claim 2 providing the means to install securely with at least mechanical fasteners, adhesives or the fixed weight of objects in said architectural interior.

5. The bed bug control barrier apparatus of claim 2 providing the means for bed bug detection in at least the cartridge element.

6. The bed bug control barrier apparatus of claim 2 providing the means for producing a multitude of interchangeable cover elements and cartridge elements.

7. The bed bug control barrier apparatus of claim 2 providing the means to mount a bed bug control barrier apparatus to a multitude of surfaces utilizing any combination of mechanical or adhesive fasteners.

8. The bed bug control barrier apparatus of claim 2 further including the means to produce mated connector apparatus to alter the path of each element included in the bed bug control barrier apparatus providing continuity at least at the juncture of contiguous surfaces.

9. The bed bug control barrier apparatus of claim 2 further including the means to produce a multitude of cartridge elements configured to install to matched containing elements.

10. The bed bug control barrier apparatus of claim 2 further including the means to produce bed bug control barrier apparatus elements fitted to mechanically formed holes in the architectural surface area.

11. A bed bug control system comprising the map apparatus of claim 1 and the barrier apparatus of claim 2.

12. The bed bug control system of claim 11 providing the means for a plurality of continuous bed bug control barrier apparatus located to assigned locations and mounted to a multitude of surfaces.

13. The bed bug control system of claim 11 further including the means to selectively remove the cover elements and cartridge elements to provide for inspections for bed bug detection.

14. The bed bug control system of claim 11 further including the means to selectively replace cover elements and cartridge elements.

15. The bed bug control system of claim 11 further including the means to contain a multitude of barrier members from any source or manufacturer.
